(19) United States
(12) Patent Application Publication
(10) Pub. No.: US 2020/0095069 A1
(43) Pub. Date: Mar. 26, 2020

(54) Device for transferring objects

(71) Applicant: C.E.R.M.E.X. CONSTRUCTIONS ETUDES ET RECHERCHES DE MATERIELS POUR L'EMBALLAGE D' EXPEDITION, CORCELLES-LES-CITEAUX (FR)

(72) Inventor: Grégory CHOPLIN, Corcelles-les-Citeaux (FR)

(21) Appl. No.: 16/495,085

(22) PCT Filed: Mar. 15, 2018
(86) PCT No.: PCT/FR2018/050628

§ 371 Date: Sep. 17, 2019

(30) Foreign Application Priority Data
Mar. 17, 2017 (FR) 1752221

(51) Int. Cl. B65G 47/71; B65G 54/02; B65G 47/04; B65B 35/10

(52) U.S. Cl. CPC B65G 47/71; B65B 35/10; B65G 47/04; B65G 54/02

(57) ABSTRACT

The present invention relates to a device for transferring objects (1) of an installation comprising at least two lines each comprising an upstream machine (2) being a blower, filler, or labeller machine, an intermediate machine (3) being a film-wrapping or boxing machine, and a palletizer (4) downstream. The transfer device comprises, for each line, at least one linear stator (5), a plurality of carriages (7), each provided with a means (8) for holding at least one object (1), and each secured to the rotor (6) configured to move along one of said linear stators (5) according to the principle of a linear motor. The transfer device also comprises at least one switch (9), configured to allow a choice between a transfer limited to one and the same line, and a transfer with change of line. The present invention relates also to a method for transferring objects implementing a device according to the invention.

The present invention lies within the field of object conveying. It relates more particularly to a device for transferring objects.

A packaging line generally comprises a blower-filler-labeler assembly, a film wrapping machine and a palletizer. The objects, having to be moved from one machine to the other, are usually transferred on single-line or multiple-line conveyors. Accumulation tables can be arranged on the processing line to manage the flows of objects. Such a type of transfer includes significant drawbacks, such as the high risk of objects falling and of jams with high rates of occurrence. Furthermore, when one machine is stopped for a lengthy period, the entire line must be stopped. Lastly, if the flow of objects at the output of the blower-filler-labeler assembly is uniform, then each line can work only on producing pallets with identical and uniform layers, composed of uniform packs.

The document WO2011131704 proposes a transfer device comprising a closed loop, on which carriages move around to make the transfer between two machines, the carriage being actuated by a linear motor. However, the system is not flexible, and the unavailability of one of the machines blocks all the processing line.

The object of the present invention is to at least partly overcome these drawbacks by proposing a flexible system for the individual transfer of each object, allowing a transfer of objects from one line to another. To this end, it proposes a device for transferring objects of an installation comprising at least two lines each comprising an upstream machine of blower-filter-labeler type, an intermediate machine in the form of a film-wrapping or boxing machine, and a palletizer downstream. Said transfer device is particular in that it comprises, for each line, at least one linear stator, a plurality of carriages, each provided with a means for holding at least one object, and each secured to a rotor configured to move along one of said linear stators according to the principle of a linear motor, and in that it comprises at least one switch, configured to allow a choice between a transfer limited to one and the same line, and a transfer with change of line.

By virtue of these provisions, it is possible to transfer objects from one line to an other, for example in the case of a prolonged stoppage of one machine or to meet particular needs, such as the production of packs composed of different objects, or of pallets composed of different packs of objects; the movement of the objects between the different machines of the line can be controlled individually, the switching commands can be performed in a centralized manner for example by loops or by lines, and adjusted in real time at high rates without the risk of droppages, of jams or of wedging of objects.

According to other features:
said holding means can be arranged above or below said rotor, so as to allow said rotor to be guided by one or both of the two opposing lateral sides, the rotor therefore being able to be guided by two different stators in the same horizontal plane, and simultaneously, in particular at the point of a switch,
said switch can be magnetically controlled, said rotor being able to be guided on one lateral side by a first stator, and by its opposing lateral side by a diversion stator, the switch thus requires no movement of parts, and can be automated to individually handle each rotor, and a centralized control can manage all the switches of the device,
each line can comprise, on the one hand, between the upstream machine and the intermediate machine and, on the other hand, between the latter and the palletizer downstream, two stators in closed loop configuration in a horizontal plane, arranged in the alignment of one another, this constituting a simple means for implementing the invention, and making it possible to manage the mixing zones between empty carriages and loaded carriages.
said device can comprise
   on the one hand between the upstream machine and the intermediate machine and
   on the other hand between the latter and the palletizer downstream,
at least one stator linking, by switches
   on the one hand, the first stator in closed loop configuration of the first line to that of the second line so as to allow the movement of carriages from the first line to the second line, and
   on the other hand, the second stator in closed loop configuration of the first line to that of the second line so as to allow the movement of carriages from the second line to the first line,
making it possible to perform transfers between two successive machines from any line to any other line,
said switch can be mechanically controlled, comprising a mechanical transfer device for guiding a first stator (5) to a diversion stator, the latter constituting an inexpensive and robust means for implementing the invention.

The present invention relates also to a method for transferring objects in an installation comprising at least two lines each comprising an upstream machine of blower-filler-labeler type, an intermediate machine in the form of a film-wrapping or boxing machine, and a palletizer downstream, characterized in that it is implemented by a device as claimed in one of the preceding claims.

By virtue of these provisions, it is possible to transfer objects from one line to another, for example in the case of the stoppage of a machine or to meet particular needs, such as the provision of packs composed of different objects, and/or of pallets composed of different packs; the movement of the objects between the different machines of the line being able to be controlled individually, the switching commands can be performed in a centralized manner and adjusted in real time at high rates without a significant risk of dropping, jamming wedging of objects.

According to other features:
one of the machines of a line can be stopped, and the other machines of said line are operating, the objects being transferred to at least one other line just before said machine that is stopped, and/or from at least one other line to said line just after said machine that is stopped, this making it possible to not have to stop all of a line when one of the machines of that line is stopped,
said device can comprise at least two lines, an intermediate machine being stopped on one line, and the objects being distributed to the other intermediate machines, then a similar number of objects being brought to the palletizer of said line, so the upstream machine and the palletizer of the line on which the intermediate machine is stopped can continue to operate,
the upstream machine of the first line can produce objects that are different from that of the second line, and some of the objects of the first line can be transferred before the palletizer to the second line, and some of the objects of the second line can be transferred before the palletizer to the first line, so as to allow the palletizer to produce pallets with layers of different objects, this type of pallet being useful for example to deliver outputs of drinks having little storage space,
the upstream machine of the first line can produce objects that are different from that of the second line, and some of the objects of the first line can be transferred before the intermediate machine to the second line, and some of the objects of the second line can be transferred before the palletizer to the first line, so that the film-wrapping machine or the boxing machine can produce packs of at least two distinct objects, making it possible for example to insert a promotional object into a pack of conventional objects, or to produce packs containing a bottle of syrup and 5 bottles of water, or to produce packs comprising different juices if the sizes of the bottles are consistent.

The present invention will be better understood on reading the followed detailed description, with reference to the attached figures in which:

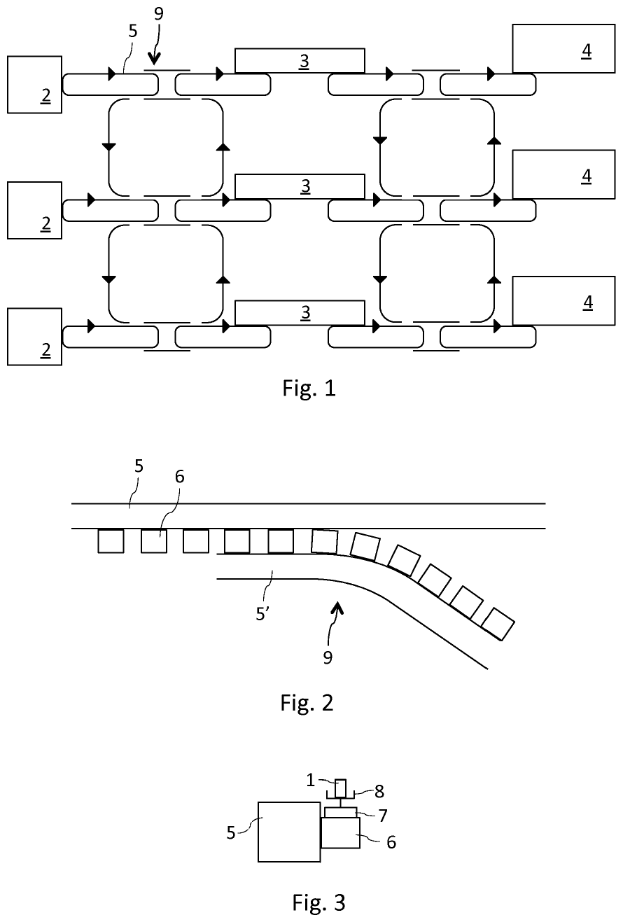

FIG. 1 is a schematic view of a device according to the invention,

FIG. 2 is a view of a detail of FIG. 1,

FIG. 3 is a cross sectional view of an object being transported by a rotor according to the invention.

The transfer device according to the invention, represented in FIGS. 1 to 3. comprises at least two lines for processing objects 1. Each line comprises an upstream machine 2, which can be a blower-filler-labeler, an intermediate machine 3, which is a film-wrapping machine or a boxing machine, and a palletizer 4 downstream, and a flow of products is set up preferably in this line in normal operation.

An object can consist for example of a bottle or a carton of fruit juice or of milk which leaves the machine upstream. These objects are then film-wrapped or boxed on the intermediate machine 3, and packs or boxes are obtained, which are then transferred in single entity form to the palletizer. Such packs or boxes are also considered as objects in the context of the present invention, objects which are then transferred individually to the palletizer 4 downstream.

The device also comprises, for each line, at least one linear stator 5, on which rotors 6 move according to the principle of a linear motor. As illustrated in FIG. 3, to each rotor 6 there is fixed a carriage 7, provided with a means 8 for holding an object 1. The objects 1, in the form of an individual bottle or carton on the one hand, or in the form of packs produced by the film-wrapping machines, or boxes produced by the boxing machines on the other hand, can therefore be transferred individually along the stators 5, via the rotors 6 that are controlled in a centralized manner.

In particular, at the output of the upstream machine, the holding means 8 being individual for each object 1, such as a plate or a clamp gripping a container by its neck, the risk of the dropping of objects 1 is highly reduced and the risk of wedging or of jamming that are commonplace in the use of conveyors is eliminated.

Such devices make it possible to arrange for the control of the device to have permanently, for each object 1, in the form of an individual bottle or carton on the one hand, or in the form of packs produced by the film-wrapping machines, or boxes produced by the boxing machines on the other hand, individual information on position, as well as its planned destination. There is a positive referencing of each object 1.

The device finally comprises at least one switch 9. The switch 9 can be configured either to leave the object 1 on the same line or to transfer the object 1 to another line.

In a preferred embodiment of the invention, the holding means 8 is arranged above or below the rotor 6. Thus, the rotor 6 can be guided by one of its lateral sides, cooperating with the stator 5. This makes it possible for example to produce a switch 9 with magnetic control, the implementation of which can proceed, as illustrated in FIG. 2, according to the following steps:
the rotor 6, on approaching the switch 9, moves along an upstream stator 5 via the contact of one of its lateral sides with the upstream stator 5.
at the switch 9, the rotor 6 enters into magnetic contact with a diversion stator 5′, via its opposing lateral side,
the magnetic contact between the stator 5 and the rotor 6 is deactivated,
at the output of the switch, the rotor 6 continues to advance on the diversion stator 5′.

The rotors 6 being controlled individually, the switch 9 with magnetic control makes it possible to switch each rotor 6 individually, and therefore provides the device according to the invention with a very high degree of flexibility. It is for example possible to transfer one object 1 in every two to the diversion stator 5′ and to leave one object 1 in every two on its original stator, or any other type of necessary distribution.

In another embodiment that is not represented, the switch 9 can be mechanically controlled. The switch 9 then comprises a mechanical transfer device for the guiding of a first stator 5 to a diversion stator. This embodiment presents the drawback that it requires moving parts to actuate the switch 9.

In the embodiment illustrated in FIG. 1, each line of the device according to the invention comprises, on the one hand, between the upstream machine 2 and the intermediate machine 3 and, on the other hand, between the intermediate machine 3 and the palletizer 4 downstream, two stators 5 in closed loop configuration in a horizontal plane. These two stators 5 can be arranged in the alignment of one another and linked by switches 9. The objects 1 to be transferred between two successive machines 2, 3, 4 of one and the same line pass over both the stators 5. It is then possible to provide, as illustrated in FIG. 1, additional stators 5 situated between the lines of the device and arranged between the machines 2 and 3, and between the machines 3 and 4, in order to link:
the first stator 5 in closed loop configuration of a first line to the first stator 5 in closed loop configuration of the next line, in order to allow the transfer of objects 1 from a first line to the next line,
the second stator 5 in closed loop configuration of a first line to the second stator 5 in closed loop configuration of the next line, in order to allow the transfer of objects 1 from the next line to the first line.

It is then possible, for an object 1 from an upstream machine 2, to continue on the same line and to be processed by the intermediate machine 3 of the same line, or to change line and be processed by the intermediate machine 3 of any other line. The same applies for an object 1 from an intermediate machine 3, and which can be transferred to the palletizer 4 of any line.

The embodiment of FIG. 1 makes it possible, when, on a given line, just one of the machines 2, 3, 4 is stopped, for the objects 1 present upstream on this same line to be able to be transferred to another line, or distributed over several other lines if the device comprises at least three lines. However, this transfer method can operate also with at least two lines. The objects 1 can then be processed by the corresponding machine 2, 3, 4 of another line. Since the rotors 6 are controlled individually in a centralized manner, the distribution of the objects 1 to other lines is flexible; it can be done according to the load level that the other lines are already supporting, and can be reconfigured in real time. Once the objects 1 have been processed by the corresponding machine 2, 3 of another line, they can be transferred or not to their original line for the next machine 3, 4.

By virtue of the device according to the invention, in the case of maintenance of a machine 2, 3, 4, it is not necessary to stop all the line. Each machine 2, 3, 4 can be stopped for the time required, the rest of the line continuing to operate.

For example in the embodiment illustrated in FIG. 1, in the case of maintenance of the film-wrapping machine 3 of the second line, the objects 1 coming from the upstream machine 2 of the second line can be distributed to the film-wrapping machines 3 of the first line and of the third line, or indeed of a fourth or fifth line, then redirected at the output of the film-wrapping machine 3 to the palletizer 4 of the second line.

The centralized individual control of the carriages 7 makes it possible, on the restarting of a machine 2, 3, 4, for it to be very easily possible to send a reduced flow of objects 1 to test the machine 2, 3, 4, then gradually increase the load to the normal production rate.

For example, if the palletizer 4 of the first line is stopped, it is possible to consider having the objects 1 at the output of the film-wrapping machine 3 of the first line being transferred to the palletizers 4 of the second and third lines, or even more lines. When the palletizer 4 of the first line is restarted, it is possible to continue to send most of the objects 1 to the palletizers 4 of the second and third lines for the palletizer 4 of the first line to restart at a low rate, before gradually increasing the rate of the palletizer 4 of the first line until there is no longer a need to transfer the objects 1 to the palletizers of the second and third lines.

Another advantage of the present invention is that, in the case of the installation of an additional line in the device, each machine can start independently of the other machines of the line and particularly of the preceding machine, which allows for a much more flexible startup of the new line, and one that is easier to organize.

The device according to the embodiment of FIG. 1 can also be used to produce pallets whose layers each comprise at least two different objects 1, for example according to the following method:
The upstream machine 2 of the first line produces objects A, that of the second line produces objects B, and that of the third line produces objects C.
At the output of the film-wrapping machine 3, there are obtained, for the first line, packs of objects A, on the second line, packs of objects B and, on the third line, packs of objects C.
By partially transferring the packs of objects of each line to the palletizers of the other lines, it is possible to obtain pallets in which one layer is composed of packs of objects A, the next layer is composed of packs of objects B and the next layer is composed of packs of objects C. It is also possible to obtain packs of different objects in one and the same layer or one and the same pallet.

Such a method can be of particular benefit for delivering to clients who have a low consumption for each type of product.

The film-wrapping machines 3 of the different lines can also produce packs of objects 1 of different sizes. By distributing some of the packs at the output of the film-wrapping machine 3 to the palletizers 4 of the other lines, it is possible to obtain multiple-format pallets, comprising layers with packs of different sizes. It is possible to consider, for example, having the film-wrapping machine 3 of the first line produce packs of 6 bottles, that of the second line produce packs of 12 and that of the third line produce packs of 24. By shrewdly distributing the packs to the palletizers 4, by virtue of the individual control of the movement of each pack, it is possible to produce pallets comprising, alternately, one layer of packs of 6 objects 1, one layer of packs of 12 objects 1 and one layer of packs of 24 objects 1.

Such multiple-format pallets can be particularly useful for procuring intermediate stocks, from which packs suited to each final destination can leave. However, such multiple-formal pallets make it possible to avoid repackaging, i.e. the pallet no longer has to pass through an intermediate packaging company, the pallet is ready directly for the final vendor.

The device can finally be used to produce packs comprising different products. The method for obtaining packs of different products comprises a step of transfer of objects 1 of different types originating from different lines to a common film-wrapping machine or boxing machine. It is thus possible to produce packs comprising a promotional product, for example according to the following method implementing a device comprising five lines:
The upstream machine 2 of the first line produces objects X₁, that of the second line produces objects X₂, that of the fourth line produces objects X₃, that of the fifth line produces objects X₄, whereas that of the third line produces promotional objects Y.
The objects Y at the output of the upstream machine 2 are partially distributed to the film-wrapping machines 3 of the other lines. The individual control of the movement of each object 1 makes it possible to have, for example, each film-wrapping machine receive 5 objects X₁ from the first line then one object Y from the third line.
Some objects Y remain on the third line and are processed by the film-wrapping machine 3 of the third line in order to produce complete packs of products Y.
The film-wrapping machine 3 of the first line then produces packs of six objects 1, composed of five objects X₁ and one object Y. That takes place similarly on the second, fourth and fifth lines.

It is thus possible to produce packs comprising, for example, 5 conventional objects 1 and one object 1 to be discovered, or even 5 bottles of water and one bottle of syrup. The promotional product can it self be produced in the form of complete packs.

The fact that the objects Y are produced on the third line is one choice among others, which offers the advantage of optimization of the distances to be traveled by the objects. Other arrangements are of course possible.

As indicated previously, according to some embodiments, each line comprises, on the one hand, between the upstream machine 2 and the intermediate machine 3 and, on the other hand, between the later and the palletizer 4 downstream, two stators 5 in closed loop configuration in a horizontal plane, arranged in the alignment of one another.

In other words, the stators 5 which are located between two consecutive machines are located one after the other along the path of the objects in the line. As such, two successive stators 5 can in particular:
be completely independent of one another, that is to say with no area of contact between a stator 5 and the stator 5 which follows it as represented in FIG. 1; in this case, these two stators 5 in closed loop configuration are linked to one another using at least one other stator 5 (in closed loop configuration or not) which links them by means of switches 9;
comprise at least one common section which then belongs to the first stator and to the second stator 5; in this case, switches 9 are placed at each end of the common section; or
intersect; in this case, switches 9 are arranged at the intersections between the two stators 5 to be able to pass from the first stator 5 to the second and vice versa.

Obviously, according to these embodiments, there can be more than two stators 5 between two consecutive machines. As an example, there can be three stators 5 in closed loop configuration with common portions, or indeed, as represented in FIG. 1, there can be two stators 5 in closed loop configuration that are independent of one another linked by two other linear stators 5, that is to say going from a point A to a point B without forming a loop.

Although the above description is based on particular embodiments, it is no way limiting on the scope of the invention, and modifications can be made, in particular by the substitution of technical equivalents or by different combinations of all or some of the features developed above.

1. A device for transferring objects (1) of an installation comprising:
at least two lines each comprising an upstream machine (2) being a blower, filler, or labeller machine, an intermediate machine (3) being a film-wrapping or boxing machine, and a palletizer (4) downstream,
for each line, at least one linear stator (5), a plurality of carriages (7), each provided with a means (8) for holding at least one object (1), and each secured to a rotor (6) configured to move along one of said linear stators (5) according to the principle of a linear motor, and
at least one switch (9), configured to allow a choice between a transfer limited to one and the same line, and a transfer with change of line.

2. The device as claimed in claim 1, wherein said holding means (8) is arranged above or below said rotor (6), so as to allow said rotor (6) to be guided by one or both of two opposing lateral sides.

3. The device as claimed in claim 1, wherein, said switch (9) is mechanically controlled, comprising a mechanical transfer device for guiding a first stator (5) to a diversion stator.

4. The device as claimed in claim 1-, wherein said switch (9) is magnetically controlled, said rotor (6) being able to be guided on one lateral side by a first stator (5), and by its opposing lateral side by a diversion stator (5′).

5. The device as claimed in claim 1, wherein each line comprises, between the upstream machine (2) and the intermediate machine (3) and, between the latter and the palletizer (4) downstream, two stators (5) in closed loop configuration in a horizontal plane, arranged in the alignment of one another.

6. The device as claimed in claim 5, comprising:
between the upstream machine (2) and the intermediate machine (3) and
between the latter and the palletizer (4) downstream,
at least one stator (5) linking, by switches (9)
on the one hand, the first stator (5) in closed loop configuration of the first line to that of the second line so as to allow the movement of carriages (7) from the first line to the second line, and
on the other hand, the second stator (5) in closed loop configuration of the first line to that of the second line so as to allow the movement of carriages (7) from the second line to the first line.

7. A method for transferring objects (1) in an installation comprising at least two lines each comprising an upstream machine (2) being a blower, filler, or labeller machine, an intermediate machine (3) being a film-wrapping or boxing machine, and a palletizer (4) downstream, implemented by a device as claimed in claim 1.

8. The method for transferring objects (1) as claimed in claim 7, wherein one of the machines (2, 3, 4) of a line is stopped, and the other machines of said lines are operating, the objects being transferred to at least one other line just before said machine (3, 4) that is stopped, and/or from at least one other line to said line just after said machine (2, 3) that is stopped.

9. The method for transferring objects as claimed in claim 7, said device comprising at least two lines, wherein an intermediate machine (3) is stopped on a line, and the objects (1) are distributed to the other intermediate machines (3), then a similar number of objects (1) are brought to the palletizer (4) of said line.

10. The method for transferring objects (1) as claimed in claim 7, wherein the upstream machine (2) of the first line produces objects (1) that are different from that of the second line, and some of the objects (1) of the first line are transferred before the palletizer (4) to the second line, and some of the objects (1) of the second line are transferred before the palletizer (4) to the first line, so as to allow the palletizer (4) to produce pallets with layers of different objects (1).

11. The method for transferring objects (1) as claimed in claim 7, wherein the upstream machine (2) of the first line produces objects (1) that are different from that of the second line, and some of the objects (1) of the first line are transferred before the intermediate machine (3) to the second line, and some of the objects (1) of the second line are transferred before the palletizer (4) to the first line, so that the film-wrapping or boxing machine (3) can produce packs of at least two distinct objects (1).
